(19) United States
(12) Patent Application Publication
(10) Pub. No.: US 2026/0351179 A1
(43) Pub. Date: Nov. 5, 2026

(54) PIXEL CIRCUIT, DISPLAY DEVICE INCLUDING THE PIXEL CIRCUIT AND ELECTRONIC DEVICE INCLUDING THE DISPLAY DEVICE

(71) Applicant: Samsung Display Co., LTD., Yongin-si (KR)

(72) Inventors: DONGWOO KIM, Yongin-si (KR); KYUNG-BAE KIM, Yongin-si (KR); KEONMIN OH, Yongin-si (KR); YONGHEE LEE, Yongin-si (KR)

(21) Appl. No.: 19/656,545

(22) Filed: Apr. 23, 2026

(30) Foreign Application Priority Data
May 2, 2025 (KR) 10-2025-0057975

(51) Int. Cl. G09G 3/3233

(52) U.S. Cl. CPC G09G 3/3233; G09G 2300/0819; G09G 2300/0842; G09G 2310/08; G09G 2320/045; G09G 2330/021

(57) ABSTRACT

A pixel circuit includes a driving current generating circuit which receives a data voltage and generates a driving current based on the data voltage, a first emission circuit including a first light emitting element which emits light based on the driving current, a second emission circuit including a second light emitting element which emits light based on the driving current, a first emission control circuit which controls an emission of the first light emitting element and an emission of the second light emitting element, and a second emission control circuit which transmits the driving current to the first emission circuit or the second emission circuit.

This application claims priority to Korean Patent Application No. 10-2025-0057975, filed on May 02, 2025, and all the benefits accruing therefrom under 35 U.S.C. §119, the content of which in its entirety is herein incorporated by reference.

### BACKGROUND

### 1. Field

Embodiments of the invention relate to a pixel circuit, a display device including the pixel circuit, and an electronic device including the display device.

### 2. Description of the Related Art

Generally, a display device may include a display panel and a display panel driver. The display panel may include gate lines, data lines, and pixel circuits. The display panel driver may include a gate driver which provides gate signals to the gate lines, the data driver which provides data voltages to the data lines, and the driving controller which controls the gate driver and the data driver.

Recently, a display device for providing virtual reality (VR) or augmented reality (AR) have been attracting attention. For this purpose, a display device is desired to have high pixel per inch (PPI) and high resolution. However, a conventional pixel circuit has a limitation in implementing the display device having the high PPI and the high resolution.

### SUMMARY

Embodiments of the present disclosure provide a pixel circuit having a small area and high integration density.

Embodiments of the present disclosure provide a display device including the pixel circuit.

Embodiments of the present disclosure provide an electronic device including the display device.

However, embodiments of the present disclosure are not limited thereto, and may be variously extended without departing from the spirit and scope of the present disclosure.

According to embodiments, a pixel circuit includes a driving current generating circuit which receives a data voltage and generates a driving current based on the data voltage, a first emission circuit including a first light emitting element which emits light based on the driving current, a second emission circuit including a second light emitting element which emits light based on the driving current, a first emission control circuit which controls an emission of the first light emitting element and an emission of the second light emitting element, and a second emission control circuit which transmits the driving current to the first emission circuit or the second emission circuit.

In an embodiment, the driving current generating circuit may include a first transistor including a control electrode connected to a first node, a first electrode connected to a second node, and a second electrode connected to a third node, a second transistor including a control electrode which receives a writing gate signal, a first electrode which receives the data voltage, and a second electrode connected to the first node, and a storage capacitor including a first electrode connected to the first node and a second electrode connected to the second node.

In an embodiment, the first emission control circuit may include a third transistor including a control electrode which receives a first emission signal, a first electrode which receives a first power supply voltage, and a second electrode connected to the second node.

In an embodiment, the second emission control circuit may include a fourth transistor including a control electrode which receives a first control gate signal, a first electrode connected to the third node, and a second electrode connected to an anode electrode of the first light emitting element and a fifth transistor including a control electrode which receives a second control gate signal, a first electrode connected to the third node, and a second electrode connected to an anode electrode of the second light emitting element.

In an embodiment, the first emission circuit may further include a sixth transistor including a control electrode which receives a first initialization gate signal, a first electrode connected to the anode electrode of the first light emitting element, and a second electrode which receives an initialization voltage, where the first light emitting element may include the anode electrode connected to the first electrode of the sixth transistor and a cathode electrode which receives a second power supply voltage.

In an embodiment, the second emission circuit may further include a seventh transistor including a control electrode which receives a second initialization gate signal, a first electrode connected to the anode electrode of the second light emitting element, and a second electrode which receives an initialization voltage, where the second light emitting element may include the anode electrode connected to the first electrode of the seventh transistor and a cathode electrode which receives a second power supply voltage.

In an embodiment, the first emission control circuit may further include an eighth transistor including a control electrode which receives a second emission signal, a first electrode which receives the first power supply voltage, and a second electrode connected to the second node.

In an embodiment, the driving current generating circuit may further include a ninth transistor including a control electrode which receives a third initialization gate signal, a first electrode connected to the first node, and a second electrode which receives a reference voltage.

According to embodiments, a display device includes a display panel including a pixel circuit and a display panel driver which drives the display panel. In such embodiments, the pixel circuit includes a driving current generating circuit which receives a data voltage and generates a driving current based on the data voltage, a first emission circuit including a first light emitting element which emits light based on the driving current, a second emission circuit including a second light emitting element which emits light based on the driving current, a first emission control circuit which controls an emission of the first light emitting element and an emission of the second light emitting element, and a second emission control circuit which transmits the driving current to the first emission circuit or the second emission circuit.

In an embodiment, the driving current generating circuit may include a first transistor including a control electrode connected to a first node, a first electrode connected to a second node, and a second electrode connected to a third node, a second transistor including a control electrode which receives a writing gate signal, a first electrode which receives the data voltage, and a second electrode connected to the first node, and a storage capacitor including a first electrode connected to the first node and a second electrode connected to the second node.

In an embodiment, the first emission control circuit may include a third transistor including a control electrode which receives a first emission signal, a first electrode which receives a first power supply voltage, and a second electrode connected to the second node.

In an embodiment, the second emission control circuit may include a fourth transistor including a control electrode which receives a first control gate signal, a first electrode connected to the third node, and a second electrode connected to an anode electrode of the first light emitting element and a fifth transistor including a control electrode which receives a second control gate signal, a first electrode connected to the third node, and a second electrode connected to an anode electrode of the second light emitting element.

In an embodiment, the first emission circuit may further include a sixth transistor including a control electrode which receives a first initialization gate signal, a first electrode connected to the anode electrode of the first light emitting element, and a second electrode which receives an initialization voltage, where the first light emitting element may include the anode electrode connected to the first electrode of the sixth transistor and a cathode electrode which receives a second power supply voltage.

In an embodiment, the second emission circuit may further include a seventh transistor including a control electrode which receives a second initialization gate signal, a first electrode connected to the anode electrode of the second light emitting element, and a second electrode which receives the initialization voltage, where the second light emitting element may include the anode electrode connected to the first electrode of the seventh transistor and a cathode electrode which receives the second power supply voltage.

According to embodiments, an electronic device includes a processor which generates an input control signal and input image data, a display panel including a pixel circuit, and a display panel driver which drives the display panel based on the input control signal and the input image data. In such embodiments, the pixel circuit includes a driving current generating circuit which receives a data voltage and generates a driving current based on the data voltage, a first emission circuit including a first light emitting element which emits light based on the driving current, a second emission circuit including a second light emitting element which emits light based on the driving current, a first emission control circuit which controls an emission of the first light emitting element and an emission of the second light emitting element, and a second emission control circuit which transmits the driving current to the first emission circuit or the second emission circuit.

In an embodiment, the driving current generating circuit may include a first transistor including a control electrode connected to a first node, a first electrode connected to a second node, and a second electrode connected to a third node, a second transistor including a control electrode which receives a writing gate signal, a first electrode which receives the data voltage, and a second electrode connected to the first node, and a storage capacitor including a first electrode connected to the first node and a second electrode connected to the second node.

In an embodiment, the first emission control circuit may include a third transistor including a control electrode which receives a first emission signal, a first electrode which receives a first power supply voltage, and a second electrode connected to the second node.

In an embodiment, the second emission control circuit may include a fourth transistor including a control electrode which receives a first control gate signal, a first electrode connected to the third node, and a second electrode connected to an anode electrode of the first light emitting element and a fifth transistor including a control electrode which receives a second control gate signal, a first electrode connected to the third node, and a second electrode connected to an anode electrode of the second light emitting element.

In an embodiment, the first emission circuit may further include a sixth transistor including a control electrode which receives a first initialization gate signal, a first electrode connected to the anode electrode of the first light emitting element, and a second electrode which receives an initialization voltage, where the first light emitting element may include the anode electrode connected to the first electrode of the sixth transistor and a cathode electrode which receives a second power supply voltage.

In an embodiment, the second emission circuit may further include a seventh transistor including a control electrode which receives a second initialization gate signal, a first electrode connected to the anode electrode of the second light emitting element, and a second electrode which receives an initialization voltage, where the second light emitting element may include the anode electrode connected to the first electrode of the seventh transistor and a cathode electrode which receives a second power supply voltage.

As described above, the pixel circuit according to embodiments of the invention may include the driving current generating circuit, the first emission circuit, the second emission circuit, the first emission control circuit, and the second emission control circuit.

In such embodiments, the driving current generating circuit may receive the data voltage and may generate the driving current based on the data voltage. The first emission circuit may include the first light emitting element which emits light based on the driving current generated by the driving current generating circuit. The second emission circuit may include the second light emitting element which emits light based on the driving current generated by the driving current generating circuit. The first emission control circuit may control the emission of the first light emitting element included in the first emission circuit and the emission of the second light emitting element included in the second emission circuit. The second emission control circuit may transmit the driving current generated by the driving current generating circuit to the first emission circuit or the second emission circuit.

In such embodiments, the first emission circuit and the second emission circuit may share the driving current generating circuit, so that the number of transistors and the number of capacitors included in the display panel may decrease. The number of transistors and the number of capacitors included in the display panel decrease, so that integration density of the pixel circuit included in the display panel may increase. That is, PPI may increase. Accordingly, the pixel circuit may have a small area and high integration density, so that resolution of the display device may increase.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments of the invention.

FIG. 2 is a circuit diagram illustrating an embodiment of a pixel circuit included in a display panel included in the display device of FIG. 1.

FIG. 3 is a signal timing diagram illustrating an operation of the pixel circuit of FIG. 2.

FIG. 4 is a circuit diagram illustrating an operation of the pixel circuit of FIG. 2 in a first period of the signal timing diagram of FIG. 3.

FIG. 5 is a circuit diagram illustrating an operation of the pixel circuit of FIG. 2 in a second period of the signal timing diagram of FIG. 3.

FIG. 6 is a circuit diagram illustrating an operation of the pixel circuit of FIG. 2 in a third period of the signal timing diagram of FIG. 3.

FIG. 7 is a circuit diagram illustrating an operation of the pixel circuit of FIG. 2 in a fourth period of the signal timing diagram of FIG. 3.

FIG. 8 is a circuit diagram illustrating an operation of the pixel circuit of FIG. 2 in a fifth period of the signal timing diagram of FIG. 3.

FIG. 9 is a circuit diagram illustrating an operation of the pixel circuit of FIG. 2 in a sixth period of the signal timing diagram of FIG. 3.

FIG. 10 is a circuit diagram illustrating an embodiment of a pixel circuit included in the display panel included in the display device of FIG. 1.

FIG. 11 is a signal timing diagram illustrating an operation of the pixel circuit of FIG. 10.

FIG. 12 is a circuit diagram illustrating an embodiment of a pixel circuit included in the display panel included in the display device of FIG. 1.

FIG. 13 is a signal timing diagram illustrating an operation of the pixel circuit of FIG. 12.

FIG. 14 is a circuit diagram illustrating an embodiment of a pixel circuit included in the display panel included in the display device of FIG. 1.

FIG. 15 is a signal timing diagram illustrating an operation of the pixel circuit of FIG. 14.

FIG. 16 is a circuit diagram illustrating an embodiment of a pixel circuit included in the display panel included in the display device of FIG. 1.

FIG. 17 is a signal timing diagram illustrating an operation of the pixel circuit of FIG. 16.

FIG. 18 is a block diagram illustrating an electronic device according to embodiments of the invention.

FIG. 19 is a diagram illustrating schematics of the electronic device of FIG. 18.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, "a", "an," "the," and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, "an element" has the same meaning as “at least one element," unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, display devices in accordance with embodiments will be described in more detail with reference to the accompanying drawings. The same reference numerals are used for the same components in the drawings, and any repetitive detailed descriptions of the same components will be omitted.

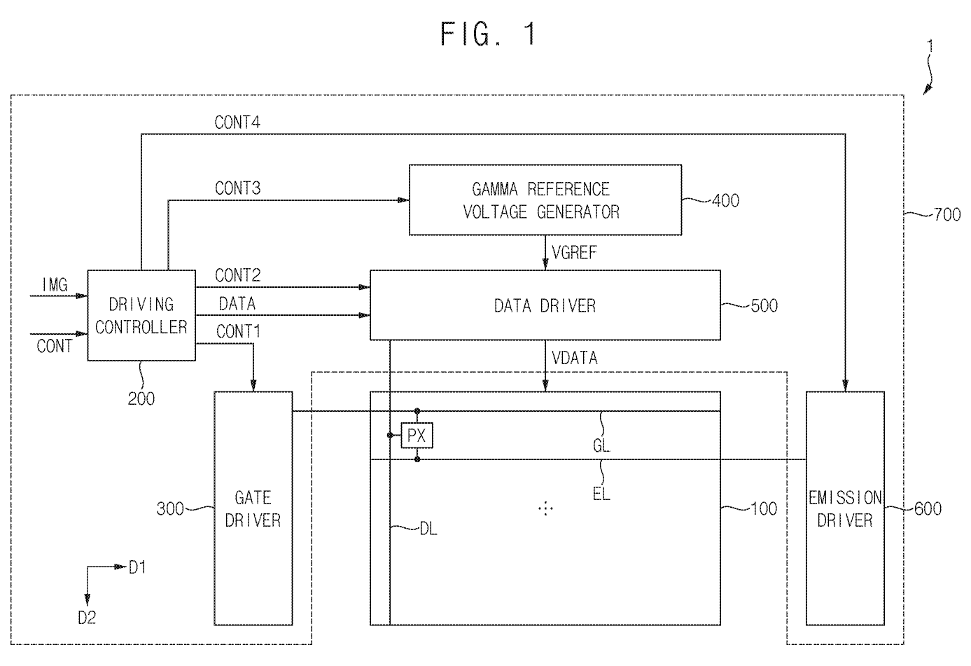

FIG. 1 is a block diagram illustrating a display device 1 according to embodiments of the invention.

Referring to FIG. 1, an embodiment of the display device 1 may include a display panel 100 and a display panel driver 700. The display panel driver 700 may include a driving controller 200, a gate driver 300, a gamma reference voltage generator 400, a data driver 500, and an emission driver 600.

In an embodiment, for example, the driving controller 200 and the data driver 500 may be integrated into a single chip. In an embodiment, for example, the driving controller 200, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region on which an image is displayed and a peripheral region adjacent to the display region. In an embodiment, for example, the peripheral region may be referred to as a bezel.

The display panel 100 may include gate lines GL, emission lines EL, data lines DL, and pixel circuits PX. In an embodiment, for example, the gate lines GL may extend in a first direction D1 and the emission lines EL may extend in the first direction D1. The data lines DL may extend in a second direction D2 crossing the first direction D1.

In an embodiment, the pixel circuit PX may include a light emitting element. The light emitting element may be a micro-organic light emitting diode (Micro-OLED). The display device 1 may be a micro-display including the Micro-OLED. In an embodiment, for example, the pixel circuit PX may be formed on a silicon substrate. The display device 1 may be a micro-display including the pixel circuits PX formed on the silicon substrate.

The driving controller 200 may receive input image data IMG and an input control signal CONT from an external device. In an embodiment, for example, the input image data IMG may include red image data, green image data, and blue image data. In some embodiments, the input image data IMG may further include white image data. In another example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, a gamma control signal CONT3, an emission control signal CONT4, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical gate start signal and a gate clock signal.

The driving controller 200 may generate the data control signal CONT2 for controlling an operation of the data driver 500 based on the input control signal CONT, and may output the data control signal CONT2 to the data driver 500. The data control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the emission control signal CONT4 for controlling an operation of the emission driver 600 based on the input control signal CONT, and may output the emission control signal CONT4 to the emission driver 600. The emission control signal CONT4 may include a vertical emission start signal and an emission clock signal.

The gate driver 300 may generate gate signals transmitted to the pixel circuits PX through the gate lines GL in response to the gate control signal CONT1 received from the driving controller 200. The gate driver 300 may output the gate signals to the gate lines GL.

In an embodiment, the gate driver 300 may be integrated on the peripheral region of the display panel 100. In another embodiment, the gate driver 300 may be mounted on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500.

In an embodiment, the gamma reference voltage generator 400 may be disposed in the driving controller 200, or in the data driver 500.

The data driver 500 may receive the data control signal CONT2 and the data signal DATA from the driving controller 200, and may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

In an embodiment, the data driver 500 may be integrated on the peripheral region of the display panel 100. In an embodiment, the data driver 500 may be mounted on the peripheral region of the display panel 100.

The emission driver 600 may generate emission signals transmitted to the pixel circuits PX through the emission lines EL in response to the emission control signal CONT4 received from the driving controller 200. The emission driver 600 may output the emission signals to the emission lines EL.

In an embodiment, the emission driver 600 may be integrated on the peripheral region of the display panel 100. In another embodiment, the emission driver 600 may be mounted on the peripheral region of the display panel 100.

In an embodiment, the pixel circuit PX may include a driving current generating circuit, a first emission circuit, a second emission circuit, a first emission control circuit, and a second emission control circuit. In an embodiment, for example, the first emission circuit may be disposed in an N-th pixel row of the display panel 100, and the second emission circuit may be disposed in an (N+1)-th pixel row of the display panel 100. Here, N is a positive integer equal to or greater than 1.

The driving current generating circuit may receive the data voltage VDATA and may generate a driving current based on the data voltage VDATA.

The first emission circuit may include a first light emitting element which emits light based on the driving current generated by the driving current generating circuit.

The second emission circuit may include a second light emitting element which emits light based on the driving current generated by the driving current generating circuit.

The first emission control circuit may control an emission of the first light emitting element included in the first emission circuit and an emission of the second light emitting element included in the second emission circuit.

The second emission control circuit may transmit the driving current generated by the driving current generating circuit to the first emission circuit or the second emission circuit.

In an embodiment, the first emission circuit and the second emission circuit may share the driving current generating circuit, so that the number of transistors and the number of capacitors included in the display panel 100 may decrease. The number of transistors and the number of capacitors included in the display panel 100 decrease, so that an integration density of the pixel circuit PX included in the display panel 100 may increase. That is, pixel per inch (PPI) may increase. Accordingly, the pixel circuit PX may have a small area and high integration density, so that resolution of the display device 1 may be increased.

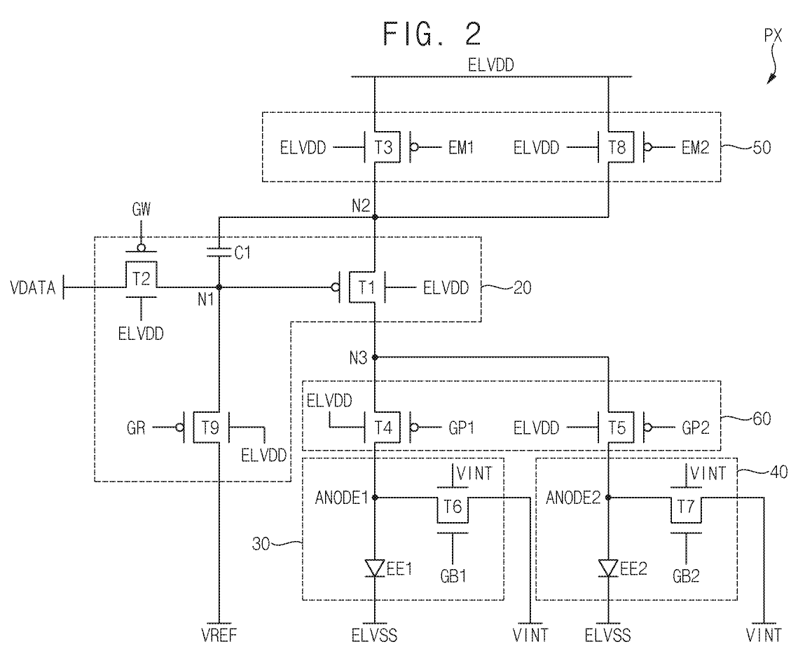

FIG. 2 is a circuit diagram illustrating an embodiment of a pixel circuit PX included in the display panel 100 included in the display device 1 of FIG. 1.

Referring to FIG. 2, an embodiment of the pixel circuit PX may include the driving current generating circuit 20, the first emission circuit 30, the second emission circuit 40, the first emission control circuit 50, and the second emission control circuit 60.

In an embodiment, the driving current generating circuit 20 may receive the data voltage VDATA and may generate the driving current based on the data voltage VDATA.

The driving current generating circuit 20 may include a first transistor T1, a second transistor T2, a ninth transistor T9, and a storage capacitor C1.

The first transistor T1 may include a control electrode connected to a first node N1, a first electrode connected to a second node N2, and a second electrode connected to a third node N3. The first transistor T1 may generate the driving current based on the data voltage VDATA.

The second transistor T2 may include a control electrode which receives a writing gate signal GW, a first electrode which receives the data voltage VDATA, and a second electrode connected to the first node N1.

The ninth transistor T9 may include a control electrode which receives a third initialization gate signal GR, a first electrode connected to the first node N1, and a second electrode which receives a reference voltage VREF.

The storage capacitor C1 may include a first electrode connected to the first node N1 and a second electrode connected to the second node N2.

In an embodiment, the first emission circuit 30 may include a sixth transistor T6 and a first light emitting element EE1.

The sixth transistor T6 may include a control electrode which receives a first initialization gate signal GB1, a first electrode connected to an anode electrode ANODE1 of the first light emitting element EE1, and a second electrode which receives an initialization voltage VINT.

The first light emitting element EE1 may include the anode electrode ANODE1 connected to the first electrode of the sixth transistor T6 and a cathode electrode which receives a second power supply voltage ELVSS. The first light emitting element EE1 may emit light based on the driving current generated by the driving current generating circuit 20.

In an embodiment, the second emission circuit 40 may include a seventh transistor T7 and a second light emitting element EE2.

The seventh transistor T7 may include a control electrode which receives a second initialization gate signal GB2, a first electrode connected to an anode electrode ANODE2 of the second light emitting element EE2, and a second electrode which receives the initialization voltage VINT.

The second light emitting element EE2 may include the anode electrode ANODE2 connected to the first electrode of the seventh transistor T7 and a cathode electrode which receives the second power supply voltage ELVSS. The second light emitting element EE2 may emit light based on the driving current generated by the driving current generating circuit 20.

In an embodiment, the first emission control circuit 50 may include a third transistor T3 and an eighth transistor T8. The first emission control circuit 50 may control the emission of the first light emitting element EE1 included in the first emission circuit 30 and the emission of the second light emitting element EE2 included in the second emission circuit 40.

The third transistor T3 may include a control electrode which receives a first emission signal EM1, a first electrode which receives a first power supply voltage ELVDD, and a second electrode connected to the second node N2.

The eighth transistor T8 may include a control electrode which receives a second emission signal EM2, a first electrode which receives the first power supply voltage ELVDD, and a second electrode connected to the second node N2.

The first emission control circuit 50 controls the third transistor T3 and the eighth transistor T8 based on the first emission signal EM1 and the second emission signal EM2, so that the first emission control circuit 50 may control the emission of the first light emitting element EE1 and the emission of the second light emitting element EE2.

In an embodiment, the second emission control circuit 60 may include a fourth transistor T4 and a fifth transistor T5. The second emission control circuit 60 may transmit the driving current generated by the driving current generating circuit 20 to the first emission circuit 30 or the second emission circuit 40.

The fourth transistor T4 may include a control electrode which receives a first control gate signal GP1, a first electrode connected to a third node N3, and a second electrode connected to the anode electrode ANODE1 of the first light emitting element EE1.

The fifth transistor T5 may include a control electrode which receives a second control gate signal GP2, a first electrode connected to a third node N3, and a second electrode connected to the anode electrode ANODE2 of the second light emitting element EE2.

In an embodiment, each of the first to fifth transistors T1 to T5, the eighth transistor T8, and the ninth transistor T9 may be implemented as a P-channel metal oxide semiconductor (PMOS) transistor. In such an embodiment, each of the sixth transistor T6 and the seventh transistor T7 may be implemented as an N-channel metal oxide semiconductor (NMOS) transistor.

The first emission circuit 30 may be disposed in the N-th pixel row of the display panel 100 and the second emission circuit 40 may be disposed in the (N+1)-th pixel row of the display panel 100. In an embodiment, for example, the first emission circuit 30 may be disposed in an odd pixel row, and the second emission circuit 40 may be disposed in an even pixel row. In an embodiment, for example, the first emission circuit 30 may be disposed in a first pixel row and the second emission circuit 40 may be disposed in a second pixel row. In an embodiment, for example, the first emission circuit 30 may be disposed in a third pixel row and the second emission circuit 40 may be disposed in a fourth pixel row.

In an embodiment, the first emission circuit 30 disposed in the N-th pixel row and the second emission circuit 40 disposed in the (N+1)-th pixel row may share the driving current generating circuit 20, that is, the first emission circuit 30 disposed in the N-th pixel row and the second emission circuit 40 disposed in the (N+1)-th pixel row may be connected to a same driving current generating circuit 20. The first emission circuit 30 and the second emission circuit 40 share the driving current generating circuit 20, so that the pixel circuit PX may receive the data voltage VDATA for the first emission circuit 30 and the data voltage VDATA for the second emission circuit 40 through a same data line DL.

In such an embodiment, the first emission circuit 30 and the second emission circuit 40 share the driving current generating circuit 20, so that the number of transistors and the number of capacitors included in the display panel 100 may decrease. The number of transistors and the number of capacitors included in the display panel 100 decrease, so that the integration density of the pixel circuit PX included in the display panel 100 may increase. That is, the PPI may increase. Accordingly, the pixel circuit PX may have the small area and the high integration density, so that the resolution of the display device 1 may increase.

In an embodiment, each of the first to fifth transistors T1 to T5, the eighth transistor T8, and the ninth transistor T9 may include an additional control electrode which receives the first power supply voltage ELVDD. In addition, each of the sixth transistor T6 and the seventh transistor T7 may include an additional control electrode which receives the initialization voltage VINT. Each of the first through fifth transistors T1 to T5, the eighth transistor T8, and the ninth transistor T9 includes the additional control electrode which receives the first power supply voltage ELVDD and each of the sixth transistor T6 and the seventh transistor T7 includes the additional control electrode which receives the initialization voltage VINT, so that stability of the pixel circuit PX may be improved.

In an embodiment, the first light emitting element EE1 included in the pixel circuit PX may be the Micro-OLED and the second light emitting element EE2 included in the pixel circuit PX may be the Micro-OLED. The display device 1 may be the micro-display including the Micro-OLED. In an embodiment, for example, the pixel circuit PX may be formed on the silicon substrate. In such an embodiment, the display device 1 may be the micro-display including the pixel circuits PX formed on the silicon substrate.

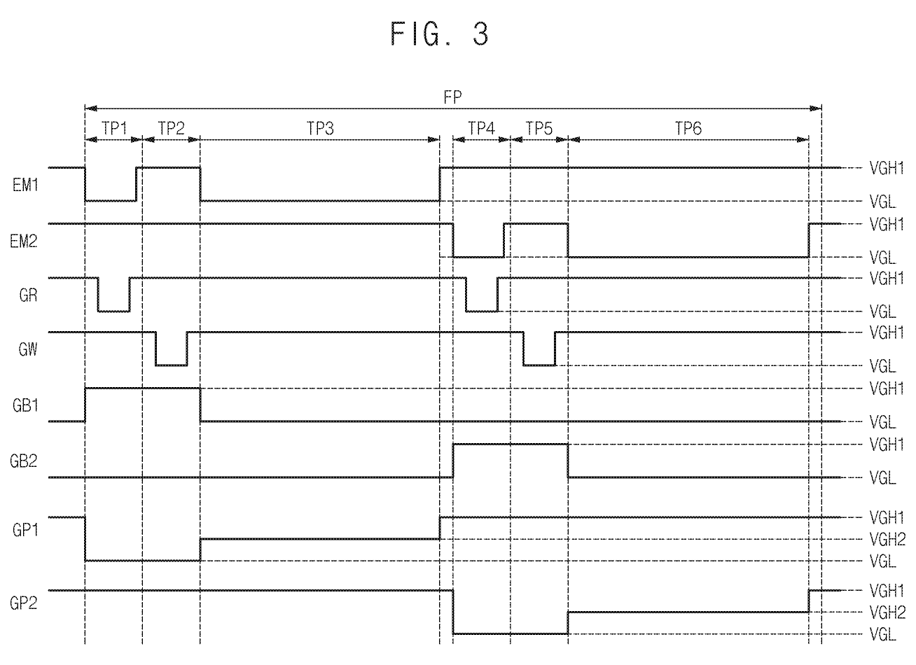

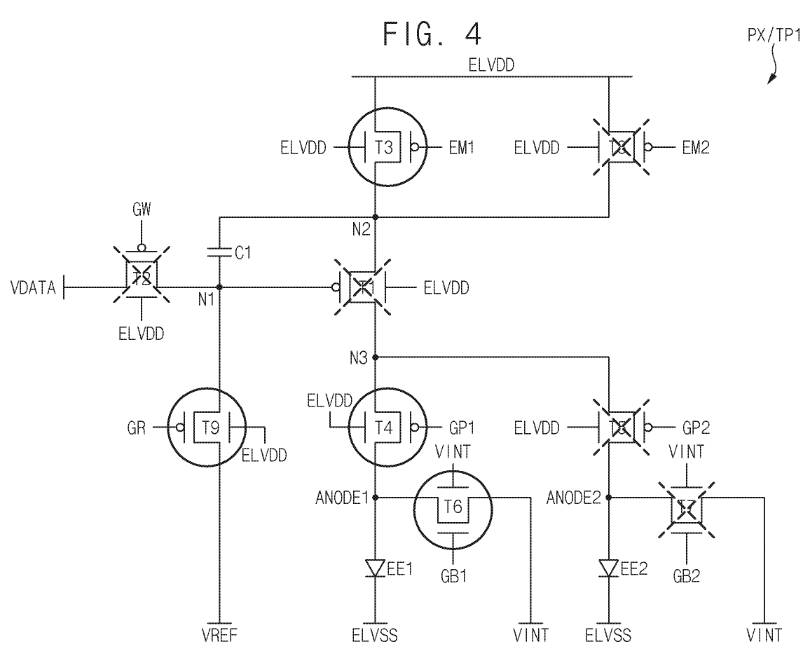

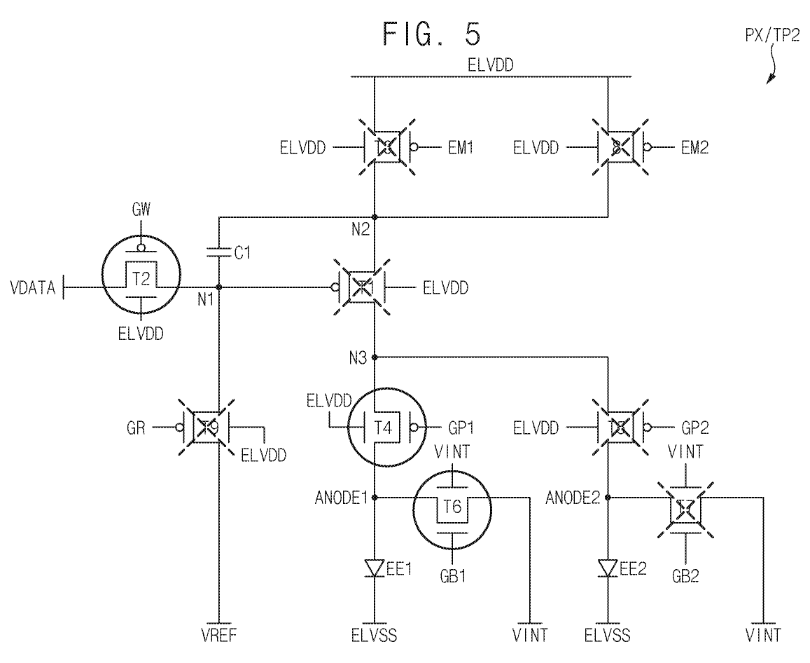

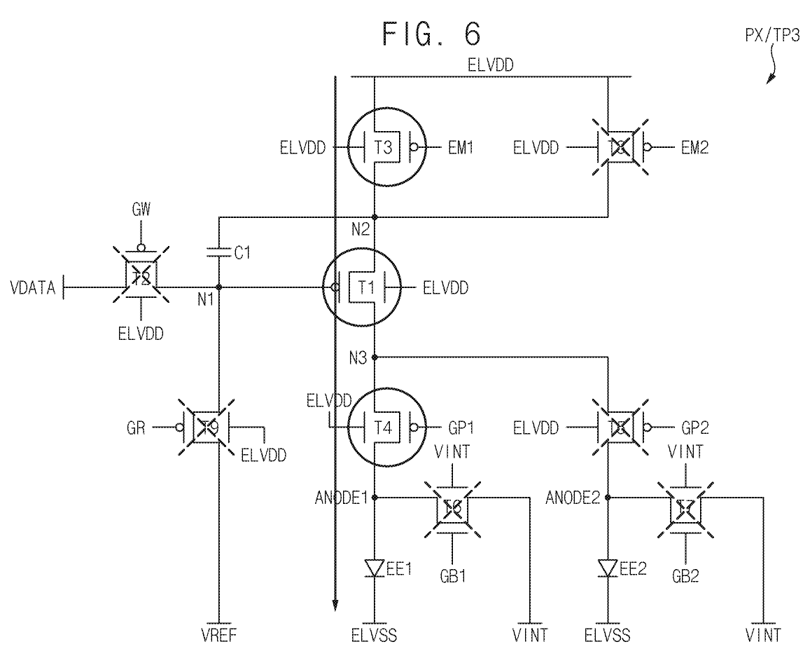

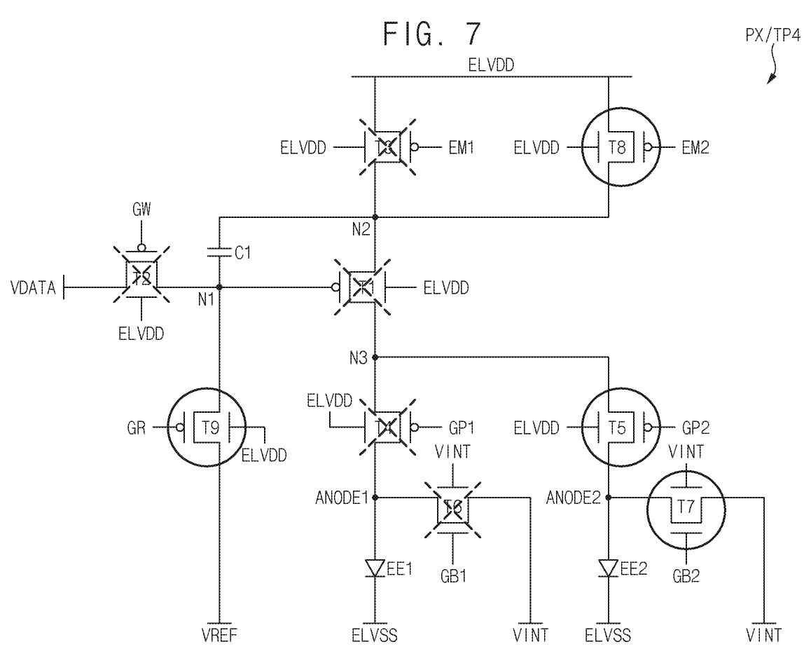

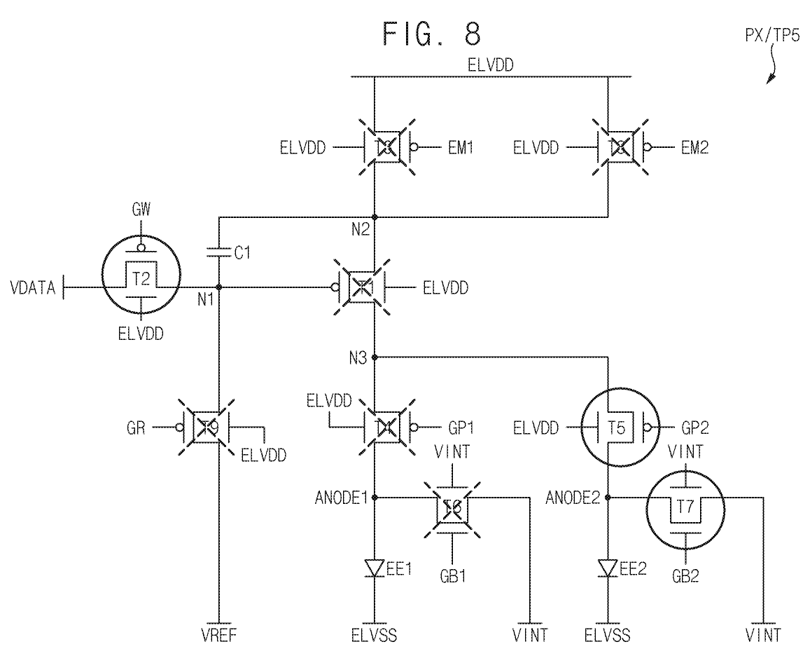

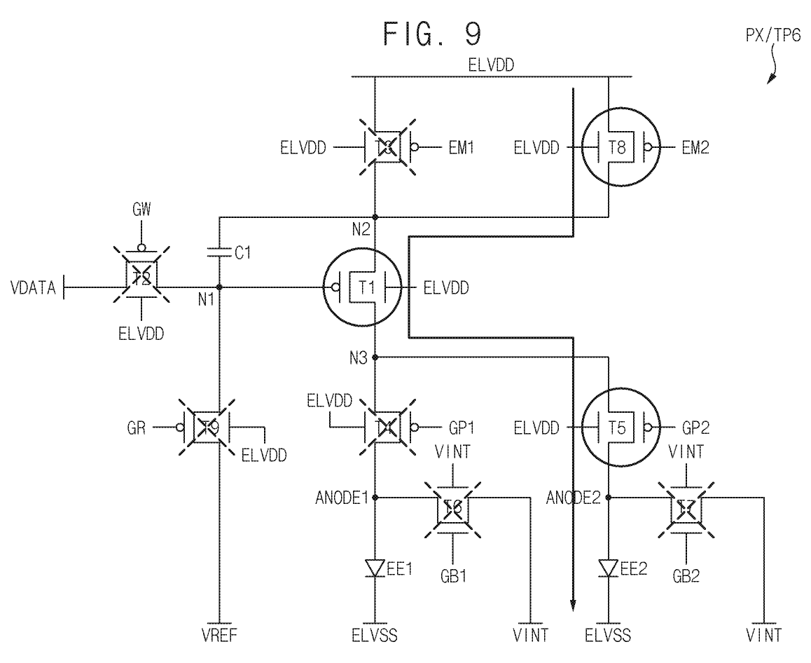

FIG. 3 is a signal timing diagram illustrating an operation of the pixel circuit PX of FIG. 2. FIG. 4 is a circuit diagram illustrating an operation of the pixel circuit PX of FIG. 2 in a first period TP1 of the signal timing diagram of FIG. 3. FIG. 5 is a circuit diagram illustrating an operation of the pixel circuit PX of FIG. 2 in a second period TP2 of the signal timing diagram of FIG. 3. FIG. 6 is a circuit diagram illustrating an operation of the pixel circuit PX of FIG. 2 in a third period TP3 of the signal timing diagram of FIG. 3. FIG. 7 is a circuit diagram illustrating an operation of the pixel circuit PX of FIG. 2 in a fourth period TP4 of the signal timing diagram of FIG. 3. FIG. 8 is a circuit diagram illustrating an operation of the pixel circuit PX of FIG. 2 in a fifth period TP5 of the signal timing diagram of FIG. 3. FIG. 9 is a circuit diagram illustrating an operation of the pixel circuit PX of FIG. 2 in a sixth period TP6 of the signal timing diagram of FIG. 3.

Referring to FIGS. 3-9, a single frame (or one frame period) may include the first to sixth periods TP1 to TP6.

The first period TP1 may be a first initialization period in which the first node N1, the second node N2, and the third node N3 are initialized.

As shown in FIGS. 3 and 4, in the first period TP1, the writing gate signal GW may have a first high level VGH1. The first initialization gate signal GB1 may have the first high level VGH1, the second initialization gate signal GB2 may have a low level VGL which is lower than the first high level VGH1, and the third initialization gate signal GR may have the low level VGL. The first control gate signal GP1 may have the low level VGL and the second control gate signal GP2 may have the first high level VGH1. In addition, the first emission signal EM1 may have the low level VGL and the second emission signal EM2 may have the first high level VGH1.

In the first period TP1, the second transistor T2 may be turned off in response to the writing gate signal GW having the first high level VGH1. The third transistor T3 may be turned on in response to the first emission signal EM1 having the low level VGL. The fourth transistor T4 may be turned on in response to the first control gate signal GP1 having the low level VGL. The fifth transistor T5 may be turned off in response to the second control gate signal GP2 having the first high level VGH1. The sixth transistor T6 may be turned on in response to the first initialization gate signal GB1 having the first high level VGH1. The seventh transistor T7 may be turned off in response to the second initialization gate signal GB2 having the low level VGL. The eighth transistor T8 may be turned off in response to the second emission signal EM2 having the first high level VGH1. The ninth transistor T9 may be turned on in response to the third initialization gate signal GR having the low level VGL. In addition, the first transistor T1 may be turned off.

The third transistor T3, which is turned on, may transmit the first power supply voltage ELVDD to the second node N2. Accordingly, a voltage of the second node N2 may be initialized to the first power supply voltage ELVDD.

The ninth transistor T9, which is turned on, may transmit the reference voltage VREF to the first node N1. Accordingly, a voltage of the first node N1 may be initialized to the reference voltage VREF.

The sixth transistor T6, which is turned on, may transmit the initialization voltage VINT to the anode electrode ANODE1 of the first light emitting element EE1 and the fourth transistor T4, which is turned on, may transmit the initialization voltage VINT to the third node N3. Accordingly, a voltage of the third node N3 and a voltage of the anode electrode ANODE1 of the first light emitting element EE1 may be initialized to the initialization voltage VINT.

A second period TP2 may be a first data writing period and a first compensation period.

As shown in FIGS. 3 and 5, in the second period TP2, the writing gate signal GW may have the low level VGL. The first initialization gate signal GB1 may have the first high level VGH1, the second initialization gate signal GB2 may have the low level VGL, and the third initialization gate signal GR may have the first high level VGH1. The first control gate signal GP1 may have the low level VGL and the second control gate signal GP2 may have the first high level VGH1. In addition, the first emission signal EM1 may have the first high level VGH1 and the second emission signal EM2 may have the first high level VGH1.

In the second period TP2, the second transistor T2 may be turned on in response to the writing gate signal GW having the low level VGL. The third transistor T3 may be turned off in response to the first emission signal EM1 having the first high level VGH1. The fourth transistor T4 may be turned on in response to the first control gate signal GP1 having the low level VGL. The fifth transistor T5 may be turned off in response to the second control gate signal GP2 having the first high level VGH1. The sixth transistor T6 may be turned on in response to the first initialization gate signal GB1 having the first high level VGH1. The seventh transistor T7 may be turned off in response to the second initialization gate signal GB2 having the low level VGL. The eighth transistor T8 may be turned off in response to the second emission signal EM2 having the first high level VGH1. The ninth transistor T9 may be turned off in response to the third initialization gate signal GR having the first high level VGH1.

The second transistor T2, which is turned on, may transmit the data voltage VDATA to the first node N1. Accordingly, the first transistor T1 may be turned on. In the second period TP2, the first transistor T1, the fourth transistor T4, and the sixth transistor T6 are turned on, so that the voltage of the second node N2 may change. In an embodiment, for example, the voltage level of the second node N2 may decrease in the second period TP2.

When a magnitude of a difference between the voltage of the first node N1 and the voltage of the second node N2 is equal to a magnitude of a threshold voltage of the first transistor T1, the first transistor T1 may be turned off. The storage capacitor C1 may store the threshold voltage of the first transistor T1. Accordingly, the threshold voltage of the first transistor T1 may be compensated.

The third period TP3 may be a first emission period in which the first light emitting element EE1 emits light.

As shown in FIGS. 3 and 6, in the third period TP3, the writing gate signal GW may have the first high level VGH1, the first initialization gate signal GB1 may have the low level VGL, the second initialization gate signal GB2 may have the low level VGL, and the third initialization gate signal GR may have the first high level VGH1. The first control gate signal GP1 may have a second high level VGH2 which is lower than the first high level VGH1 and higher than the low level VGL and the second control gate signal GP2 may have the first high level VGH1. In addition, the first emission signal EM1 may have the low level VGL and the second emission signal EM2 may have the first high level VGH1.

In the third period TP3, the second transistor T2 may be turned off in response to the writing gate signal GW having the first high level VGH1. The third transistor T3 may be turned on in response to the first emission signal EM1 having the low level VGL. The fourth transistor T4 is turned on in response to the first control gate signal GP1 having the second high level VGH2 and the fifth transistor T5 may be turned off in response to the second control gate signal GP2 having the first high level VGH1. The sixth transistor T6 may be turned off in response to the first initialization gate signal GB1 having the low level VGL. The seventh transistor T7 may be turned off in response to the second initialization gate signal GB2 having the low level VGL. The eighth transistor T8 may be turned off in response to the second emission signal EM2 having the first high level VGH1. The ninth transistor T9 may be turned off in response to the third initialization gate signal GR having the first high level VGH1.

The third transistor T3, which is turned on, may transmit the first power supply voltage ELVDD to the second node N2. That is, the voltage of the second node N2 may have the first power supply voltage ELVDD. Accordingly, the first transistor T1 may be turned on.

The first transistor T1, which is turned on, may generate the driving current corresponding to the data voltage VDATA. The driving current generated by the first transistor T1 may be transmitted to the first light emitting element EE1 through the fourth transistor T4 which is turned on. Accordingly, the first light emitting element EE1 may emit light at a luminance corresponding to the data voltage VDATA. The fifth transistor T5 is turned off, so that the second light emitting element EE2 may not emit light.

The first control gate signal GP1 has the second high level VGH2, so that the first transistor T1 may generate the driving current corresponding to the data voltage VDATA, which is transmitted to the first node N1 in the second period TP2, regardless of degradation of the first light emitting element EE1. Accordingly, the first light emitting element EE1 may emit light at the luminance corresponding to the data voltage VDATA, which is transmitted to the first node N1 in the second period TP2, and display quality of the display device 1 may be improved.

The fourth period TP4 may be a second initialization period in which the first node N1, the second node N2, and the third node N3 are initialized.

As shown in FIGS. 3 and 7, in the fourth period TP4, the writing gate signal GW may have the first high level VGH1. The first initialization gate signal GB1 may have the low level VGL, the second initialization gate signal GB2 may have the first high level VGH1 and the third initialization gate signal GR may have the low level VGL. The first control gate signal GP1 may have the first high level VGH1 and the second control gate signal GP2 may have the low level VGL. In addition, the first emission signal EM1 may have the first high level VGH1 and the second emission signal EM2 may have the low level VGL.

In the fourth period TP4, the second transistor T2 may be turned off in response to the writing gate signal GW having the first high level VGH1. The third transistor T3 may be turned off in response to the first emission signal EM1 having the first high level VGH1. The fourth transistor T4 may be turned off in response to the first control gate signal GP1 having the first high level VGH1. The fifth transistor T5 may be turned on in response to the second control gate signal GP2 having the low level VGL. The sixth transistor T6 may be turned off in response to the first initialization gate signal GB1 having the low level VGL. The seventh transistor T7 may be turned on in response to the second initialization gate signal GB2 having the first high level VGH1. The eighth transistor T8 may be turned on in response to the second emission signal EM2 having the low level VGL. The ninth transistor T9 may be turned on in response to the third initialization gate signal GR having the low level VGL. In addition, the first transistor T1 may be turned off.

The eighth transistor T8, which is turned on, may transmit the first power supply voltage ELVDD to the second node N2. Accordingly, the voltage of the second node N2 may be initialized to the first power supply voltage ELVDD.

The ninth transistor T9, which is turned on, may transmit the reference voltage VREF to the first node N1. Accordingly, the voltage of the first node N1 may be initialized to the reference voltage VREF.

The seventh transistor T7, which is turned on, may transmit the initialization voltage VINT to the anode electrode ANODE2 of the second light emitting element EE2 and the fifth transistor T5, which is turned on, may transmit the initialization voltage VINT to the third node N3. Accordingly, the voltage of the third node N3 and a voltage of the anode electrode ANODE2 of the second light emitting element EE2 may be initialized to the initialization voltage VINT.

The fifth period TP5 may be a second data writing period and a second compensation period.

As shown in FIGS. 3 and 8, in the fifth period TP5, the writing gate signal GW may have the low level VGL. The first initialization gate signal GB1 may have the low level VGL, the second initialization gate signal GB2 may have the first high level VGH1, and the third initialization gate signal GR may have the first high level VGH1. The first control gate signal GP1 may have the first high level VGH1 and the second control gate signal GP2 may have the low level VGL. In addition, the first emission signal EM1 may have the first high level VGH1 and the second emission signal EM2 may have the first high level VGH1.

In the fifth period TP5, the second transistor T2 may be turned on in response to the writing gate signal GW having the low level VGL. The third transistor T3 may be turned off in response to the first emission signal EM1 having the first high level VGH1. The fourth transistor T4 may be turned off in response to the first control gate signal GP1 having the first high level VGH1. The fifth transistor T5 may be turned on in response to the second control gate signal GP2 having the low level VGL. The sixth transistor T6 may be turned off in response to the first initialization gate signal GB1 having the low level VGL. The seventh transistor T7 may be turned on in response to the second initialization gate signal GB2 having the first high level VGH1. The eighth transistor T8 may be turned off in response to the second emission signal EM2 having the first high level VGH1. The ninth transistor T9 may be turned off in response to the third initialization gate signal GR having the first high level VGH1.

The second transistor T2, which is turned on, may transmit the data voltage VDATA to the first node N1. Accordingly, the first transistor T1 may be turned on. In the fifth period TP5, the first transistor T1, the fifth transistor T5, and the seventh transistor T7 are turned on, so that the voltage of the second node N2 may change. In an embodiment, for example, the voltage level of the second node N2 may decrease in the fifth period TP5.

When the magnitude of the difference between the voltage of the first node N1 and the voltage of the second node N2 is equal to the magnitude of the threshold voltage of the first transistor T1, the first transistor T1 may be turned off. The storage capacitor C1 may store the threshold voltage of the first transistor T1. That is, the threshold voltage of the first transistor T1 may be compensated.

The sixth period TP6 may be a second emission period in which the second light emitting element EE2 emits light.

As shown in FIGS. 3 and 9, in the sixth period TP6, the writing gate signal GW may have the first high level VGH1. The first initialization gate signal GB1 may have the low level VGL, the second initialization gate signal GB2 may have the low level VGL, and the third initialization gate signal GR may have the first high level VGH1. The first control gate signal GP1 may have the first high level VGH1 and the second control gate signal GP2 may have the second high level VGH2. In addition, the first emission signal EM1 may have the first high level VGH1 and the second emission signal EM2 may have the low level VGL.

In the sixth period TP6, the second transistor T2 may be turned off in response to the writing gate signal GW having the first high level VGH1. The third transistor T3 may be turned off in response to the first emission signal EM1 having the first high level VGH1. The fourth transistor T4 may be turned off in response to the first control gate signal GP1 having the first high level VGH1. The fifth transistor T5 may be turned on in response to the second control gate signal GP2 having the second high level VGH2. The sixth transistor T6 may be turned off in response to the first initialization gate signal GB1 having the low level VGL. The seventh transistor T7 may be turned off in response to the second initialization gate signal GB2 having the low level VGL. The eighth transistor T8 may be turned on in response to the second emission signal EM2 having the low level VGL. The ninth transistor T9 may be turned off in response to the third initialization gate signal GR having the first high level VGH1.

The eighth transistor T8, which is turned on, may transmit the first power supply voltage ELVDD to the second node N2. Accordingly, the voltage of the second node N2 may have the first power supply voltage ELVDD. The first transistor T1 may be turned on.

The first transistor T1, which is turned on, may generate the driving current corresponding to the data voltage VDATA. The driving current generated by the first transistor T1 may be transmitted to the second light emitting element EE2 through the fifth transistor T5 which is turned on. Accordingly, the second light emitting element EE2 may emit light at the luminance corresponding to the data voltage VDATA. The fourth transistor T4 is turned off, so that the first light emitting element EE1 may not emit light.

The second control gate signal GP2 has the second high level VGH2, so that the first transistor T1 may generate the driving current corresponding to the data voltage VDATA, which is transmitted to the first node N1 in the fifth period TP5, regardless of the degradation of the second light emitting element EE2. Accordingly, the second light emitting element EE2 may emit light at the luminance corresponding to the data voltage VDATA, which is transmitted to the first node N1 in the fifth period TP5 and the display quality of the display device 1 may be improved.

The first emission circuit 30 may be disposed in the N-th pixel row and the second emission circuit 40 may be disposed in the (N+1)-th pixel row. The first emission circuit 30 disposed in the N-th pixel row and the second emission circuit 40 disposed in the (N+1)-th pixel row may share the driving current generating circuit 20. The first emission circuit 30 and the second emission circuit 40 share the driving current generating circuit 20, so that the pixel circuit PX may receive the data voltage VDATA for the first emission circuit 30 and the data voltage VDATA for the second emission circuit 40 through a same data line DL.

The first emission circuit 30 and the second emission circuit 40 share the driving current generating circuit 20, so that the number of transistors and the number of capacitors included in the display panel 100 may decrease. The number of transistors and the number of capacitors included in the display panel 100 decrease, so that the integration density of the pixel circuit PX included in the display panel 100 may increase. That is, the PPI may increase. Accordingly, the pixel circuit PX may have the small area and the high integration density, so that the resolution of the display device 1 may increase.

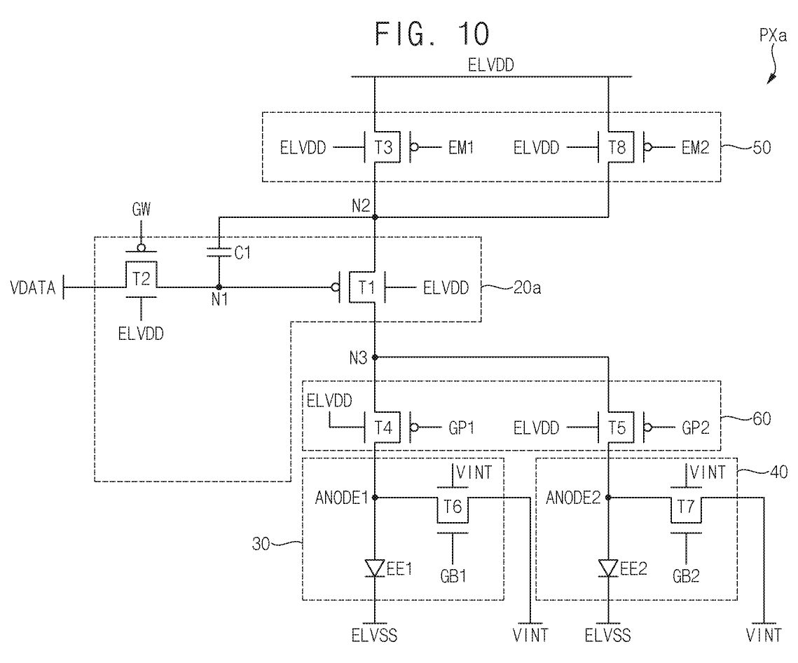

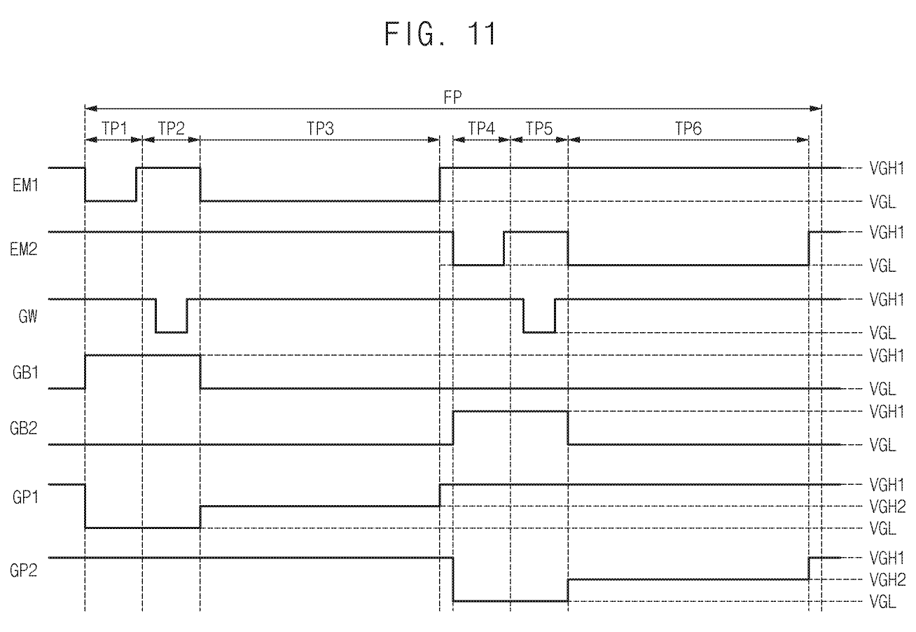

FIG. 10 is a circuit diagram illustrating an embodiment of a pixel circuit PXa included in the display panel 100 included in the display device 1 of FIG. 1. FIG. 11 is a signal timing diagram illustrating an operation of the pixel circuit PXa of FIG. 10.

Referring to FIGS. 10 and 11, an embodiment of the pixel circuit PXa may include a driving current generating circuit 20a, the first emission circuit 30, the second emission circuit 40, the first emission control circuit 50, and the second emission control circuit 60. In addition, the single frame FP may include the first to sixth periods TP1 to TP6.

The pixel circuit PXa shown in FIG. 10 is substantially the same as the pixel circuit PX of FIG. 2 except that the pixel circuit PXa does not include the ninth transistor T9. Thus, the same reference numerals will be used to refer to the same or like parts as those of the embodiment described above with reference to FIG. 2 and any repetitive detailed description thereof will be omitted.

In such an embodiment, the pixel circuit PXa may include the first to eighth transistors T1 to T8. In such an embodiment, the driving current generating circuit 20a may include the first transistor T1, the second transistor T2, and the storage capacitor C1.

The first emission circuit 30 may be disposed in the N-th pixel row and the second emission circuit 40 may be disposed in the (N+1)-th pixel row. The first emission circuit 30 disposed in the N-th pixel row and the second emission circuit 40 disposed in the (N+1)-th pixel row may share the driving current generating circuit 20a. The first emission circuit 30 and the second emission circuit 40 share the driving current generating circuit 20a, so that the pixel circuit PXa may receive the data voltage VDATA for the first emission circuit 30 and the data voltage VDATA for the second emission circuit 40 through a same data line DL.

In such an embodiment, the first emission circuit 30 and the second emission circuit 40 share the driving current generating circuit 20a, so that the number of transistors and the number of capacitors included in the display panel 100 may decrease. In addition, the pixel circuit PXa does not include the ninth transistor T9 of FIG. 2, so that the number of transistors and the number of capacitors included in the display panel 100 may further decrease.

In such an embodiment, the number of transistors and the number of capacitors included in the display panel 100 decrease, so that the integration density of the pixel circuit PXa included in the display panel 100 may increase. That is, the PPI may increase. Accordingly, the pixel circuit PXa may have the small area and the high integration density, so that the resolution of the display device 1 may increase.

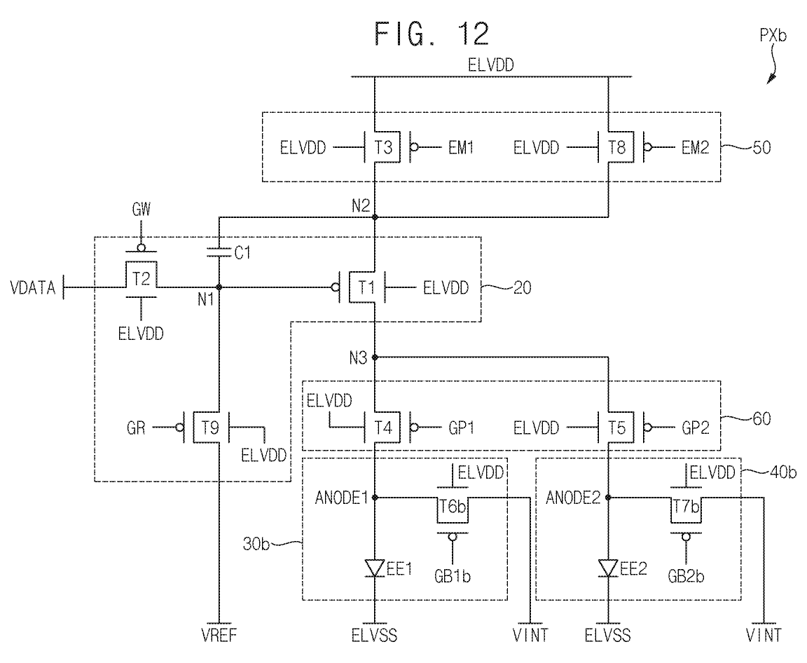

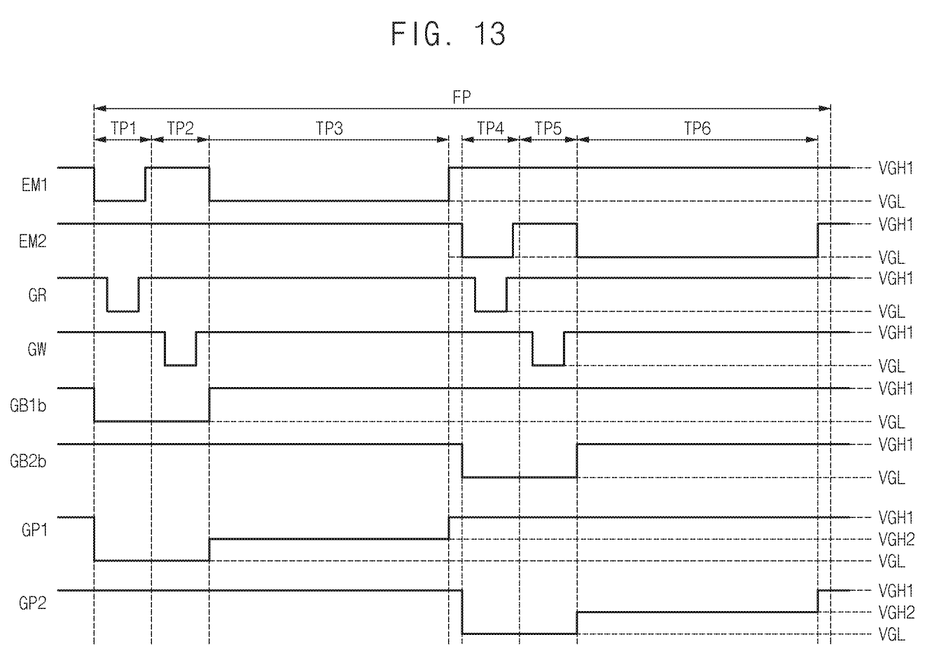

FIG. 12 is a circuit diagram illustrating an embodiment of a pixel circuit PXb included in the display panel 100 included in the display device 1 of FIG. 1. FIG. 13 is a signal timing diagram illustrating an operation of the pixel circuit PXb of FIG. 12.

Referring to FIGS. 12 and 13, an embodiment of the pixel circuit PXb may include the driving current generating circuit 20, a first emission circuit 30b, a second emission circuit 40b, the first emission control circuit 50, and the second emission control circuit 60. In addition, the single frame FP may include the first to sixth periods TP1 to TP6.

The pixel circuit PXb shown in FIG. 12 is substantially the same as the pixel circuit PX of FIG. 2 except for a type of the sixth transistor T6b, a type of the seventh transistor T7b, a level of the first initialization gate signal GB1b, and a level of the second initialization gate signal GB2b. Thus, the same reference numerals will be used to refer to the same or like parts as those of the embodiment described above with reference to FIG. 2 and any repetitive detailed description thereof will be omitted.

In such an embodiment, the sixth transistor T6b may be implemented as the PMOS transistor. In addition, the seventh transistor T7b may be implemented as the PMOS transistor.

The sixth transistor T6b is implemented as the PMOS transistor, so that the first initialization gate signal GB1b may have the low level VGL in the first period TP1 and the second period TP2 and the first initialization gate signal GB1b may have the first high level VGH1 in the third to sixth periods TP3 to TP6.

The sixth transistor T6b is implemented as the PMOS transistor, so that the sixth transistor T6b may be turned on in response to the first initialization gate signal GB1b having the low level VGL and may be turned off in response to the first initialization gate signal GB1b having the first high level VGH1.

The seventh transistor T7b is implemented as the PMOS transistor, so that the second initialization gate signal GB2b may have the low level VGL in the fourth period TP4 and the fifth period TP5 and the second initialization gate signal GB2b may have the first high level VGH1 in the first to third periods TP1 to TP3 and the sixth period TP6.

The seventh transistor T7b is implemented as the PMOS transistor, so that the seventh transistor T7b may be turned on in response to the second initialization gate signal GB2b having the low level VGL and may be turned off in response to the second initialization gate signal GB2b having the first high level VGH1.

The sixth transistor T6b is implemented as the PMOS transistor, so that the additional control electrode of the sixth transistor T6b may receive the first power supply voltage ELVDD. The sixth transistor T6b receives the first power supply voltage ELVDD through the additional control electrode, so that the stability of the pixel circuit PXb may be improved.

The additional control electrode of the fourth transistor T4 and the additional control electrode of the sixth transistor T6b receive the first power supply voltage ELVDD, so that the additional control electrode of the fourth transistor T4 and the additional control electrode of the sixth transistor T6b may be connected to the same first power supply voltage line. That is, the additional control electrode of the fourth transistor T4 and the additional control electrode of the sixth transistor T6b are connected to the same first power supply voltage line, so that the sixth transistor T6b may be allowed to be disposed closer to the fourth transistor T4 than the sixth transistor T6 included in the pixel circuit PX of FIG. 2.

The seventh transistor T7b is implemented as the PMOS transistor, so that the additional control electrode of the seventh transistor T7b may receive the first power supply voltage ELVDD. The seventh transistor T7b receives the first power supply voltage ELVDD through the additional control electrode, so that the stability of the pixel circuit PXb may be improved.

The additional control electrode of the fifth transistor T5 and the additional control electrode of the seventh transistor T7b receive the first power supply voltage ELVDD, so that the additional control electrode of the fifth transistor T5 and the additional control electrode of the seventh transistor T7b may be connected to the same first power supply voltage line. That is, the additional control electrode of the fifth transistor T5 and the additional control electrode of the seventh transistor T7b are connected to the same first power supply voltage line, so that the seventh transistor T7b may be allowed to be disposed closer to the fifth transistor T5 than the seventh transistor T7 included in the pixel circuit PX of FIG. 2.

In such an embodiment, the sixth transistor T6b is disposed closer to the fourth transistor T4 than the sixth transistor T6 included in the pixel circuit PX of FIG. 2 and the seventh transistor T7b is disposed closer to the fifth transistor T5 than the seventh transistor T7 included in the pixel circuit PX of FIG. 2, so that a dead space of the display device 1 including the pixel circuit PXb may decrease. The dead space of the display device 1 decreases, so that the integration density of the pixel circuit PXb may increase. That is, the PPI may increase. Accordingly, the pixel circuit PXb may have the small area and the high integration density, so that the resolution of the display device 1 may increase.

In addition, the dead space of the display device 1 decreases, so that power consumption of the display device 1 may be reduced.

In such an embodiment, the first emission circuit 30b and the second emission circuit 40b share the driving current generating circuit 20, so that the number of transistors and the number of capacitors included in the display panel 100 may decrease. The number of transistors and the number of capacitors included in the display panel 100 decrease, so that the integration density of the pixel circuit PXb included in the display panel 100 may increase. That is, the PPI may increase. Accordingly, the pixel circuit PXb may have the small area and the high integration density, so that the resolution of the display device 1 may increase.

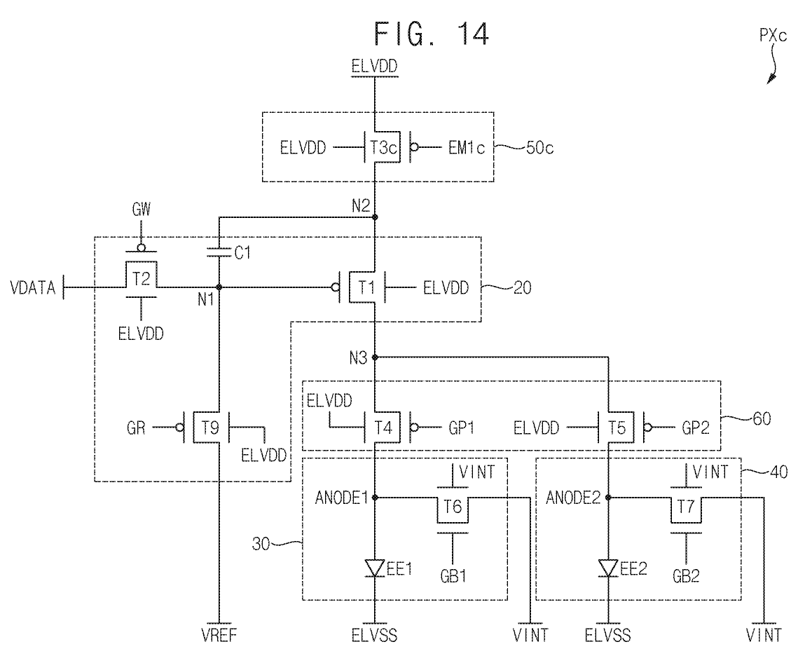

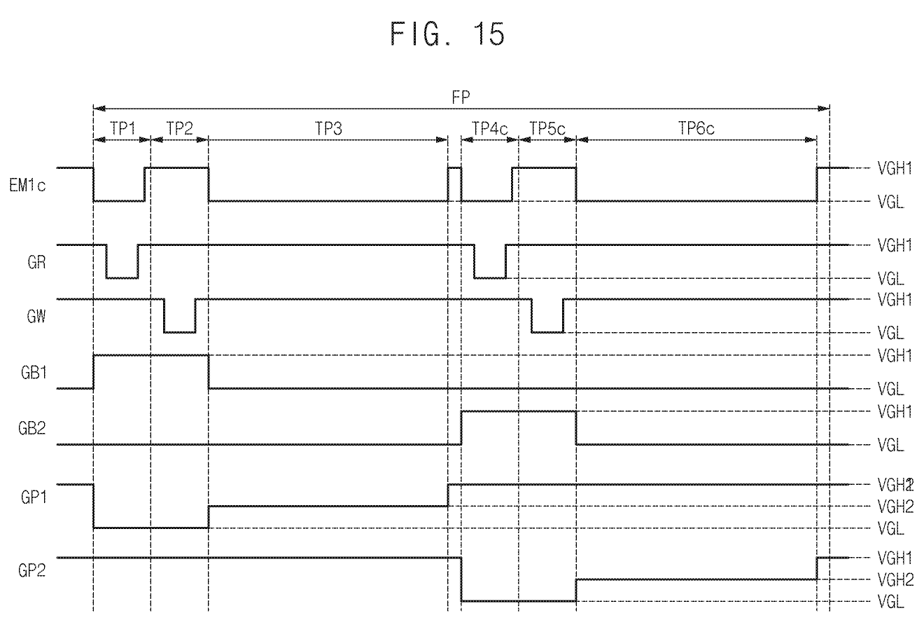

FIG. 14 is a circuit diagram illustrating an embodiment of a pixel circuit PXc included in the display panel 100 included in the display device 1 of FIG. 1. FIG. 15 is a signal timing diagram illustrating an operation of the pixel circuit PXc of FIG. 14.

Referring to FIGS. 14 and 15, an embodiment of the pixel circuit PXc may include the driving current generating circuit 20, the first emission circuit 30, a second emission circuit 40, a first emission control circuit 50c, and the second emission control circuit 60. In addition, the single frame FP may include the first to sixth periods TP1 to TP6c.

The pixel circuit PXc shown in FIG. 14 is substantially the same as the pixel circuit PX of FIG. 2 except that the pixel circuit PXc does not include the eighth transistor T8 and the level of the first emission signal EM1c in the fourth to sixth periods TP4c to TP6c is different from the level of the first emission signal EM1 applied to the pixel circuit PX in the fourth to sixth period TP4 to TP6. Thus, the same reference numerals will be used to refer to the same or like parts as those of the embodiment described above with reference to FIG. 2 and any repetitive detailed description thereof will be omitted.

In such an embodiment, the pixel circuit PXc may include the first to seventh transistors T1 to T7 and the ninth transistor T9. That is, the first emission control circuit 50c may include the third transistor T3c.

In the fourth period TP4c, the first emission signal EM1c may have the low level VGL. The third transistor T3c may be turned on in response to the first emission signal EM1c having the low level VGL.

The third transistor T3c, which is turned on, in the fourth period TP4c may transmit the first power supply voltage ELVDD to the second node N2. The voltage of the second node N2 may be initialized to the first power supply voltage ELVDD.

The first emission signal EM1c in the fifth period TP5c may have the first high level VGH1. The third transistor T3c may be turned off in response to the first emission signal EM1c which has the first high level VGH1.

The first emission signal EM1c in the sixth period TP6c may have the low level VGL. The third transistor T3c may be turned on in response to the first emission signal EM1c which has the low level VGL.

The third transistor T3c, which is turned on, in the sixth period TP6c may transmit the first power supply voltage ELVDD to the second node N2. The voltage of the second node N2 may be the first power supply voltage ELVDD. The first transistor T1 may be turned on.

In such an embodiment, the first emission circuit 30 may be disposed in the N-th pixel row and the second emission circuit 40 may be disposed in the (N+1)-th pixel row. The first emission circuit 30 disposed in the N-th pixel row and the second emission circuit 40 disposed in the (N+1)-th pixel row may share the driving current generating circuit 20. The first emission circuit 30 and the second emission circuit 40 share the driving current generating circuit 20, so that the pixel circuit PXc may receive the data voltage VDATA for the first emission circuit 30 and the data voltage VDATA for the second emission circuit 40 through a same data line DL.

In such an embodiment, the first emission circuit 30 and the second emission circuit 40 share the driving current generating circuit 20, so that the number of transistors and the number of capacitors included in the display panel 100 may decrease. In addition, the pixel circuit PXc does not include the eighth transistor T8 of FIG. 2, so that the number of transistors and the number of capacitors included in the display panel 100 may further decrease.

In such an embodiment, the number of transistors and the number of capacitors included in the display panel 100 decrease, so that the integration density of the pixel circuit PXc included in the display panel 100 may be increased. That is, the PPI may be increased. Accordingly, the pixel circuit PXc may have the small area and the high integration density, so that the resolution of the display device 1 may increase.

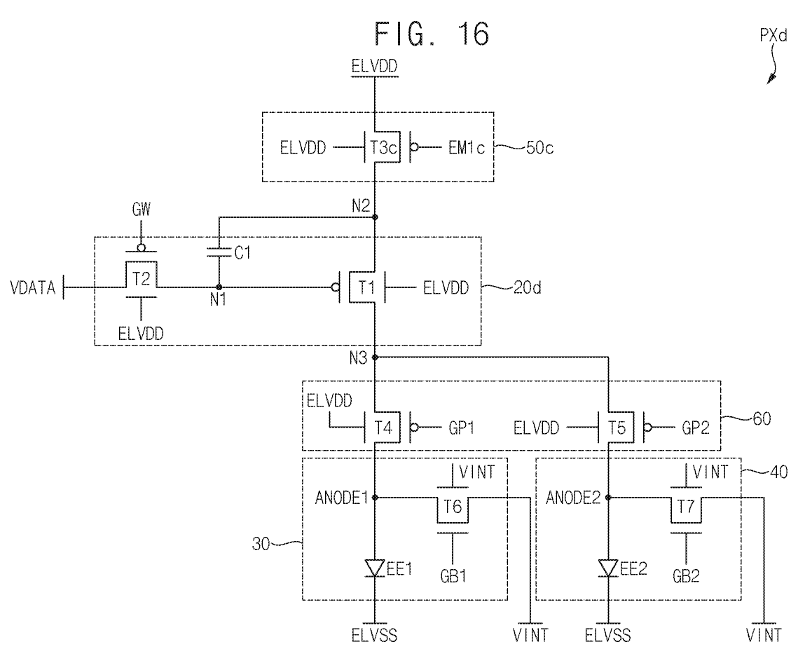

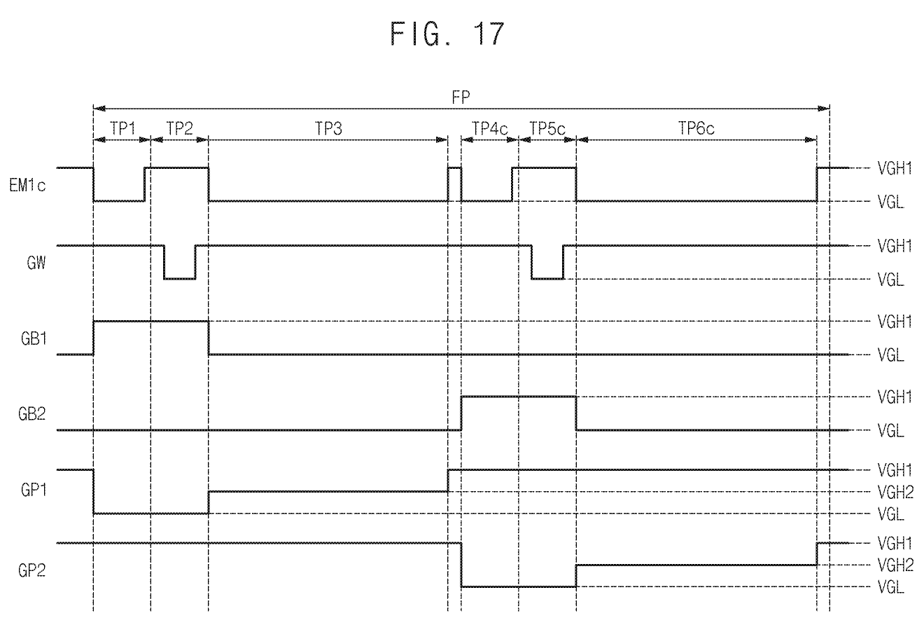

FIG. 16 is a circuit diagram illustrating an embodiment of a pixel circuit PXd included in the display panel 100 included in the display device 1 of FIG. 1. FIG. 17 is a signal timing diagram illustrating an operation of the pixel circuit PXd of FIG. 16.

Referring to FIGS. 16 and 17, an embodiment of the pixel circuit PXd may include a driving current generating circuit 20d, the first emission circuit 30, the second emission circuit 40, the first emission control circuit 50c, and the second emission control circuit 60. The single frame FP may include the first to sixth periods TP1 to TP6c.

The pixel circuit PXd shown in FIG. 16 is substantially the same as the pixel circuit PXc of FIG. 14 except that the pixel circuit PXd does not include the ninth transistor T9. Thus, the same reference numerals will be used to refer to the same or like parts as those of the embodiment described above with reference to FIG. 14 and any repetitive detailed description thereof will be omitted.

In such an embodiment, the pixel circuit PXd may include the first to seventh transistors T1 to T7. That is, the driving current generating circuit 20d may include the first transistor T1, the second transistor T2, and the storage capacitor C1, and the first emission control circuit 50c may include the third transistor T3c.

In such an embodiment, the first emission circuit 30 may be disposed in the N-th pixel row and the second emission circuit 40 may be disposed in the (N+1)-th pixel row. The first emission circuit 30 disposed in the N-th pixel row and the second emission circuit 40 disposed in the (N+1)-th pixel row may share the driving current generating circuit 20d. The first emission circuit 30 and the second emission circuit 40 share the driving current generating circuit 20d, so that the pixel circuit PXd may receive the data voltage VDATA for the first emission circuit 30 and the data voltage VDATA for the second emission circuit 40 through a same data line DL.

In such an embodiment, the first emission circuit 30 and the second emission circuit 40 share the driving current generating circuit 20d, so that the number of transistors and the number of capacitors included in the display panel 100 may decrease. In addition, the pixel circuit PXd does not include the eighth transistor T8 of FIG. 2 and the ninth transistor T9 of FIG. 2, so that the number of transistors and the number of capacitors included in the display panel 100 may further decrease.

In such an embodiment, the number of transistors and the number of capacitors included in the display panel 100 decrease, so that the integration density of the pixel circuit PXd included in the display panel 100 may increase. That is, the PPI may increase. Accordingly, the pixel circuit PXd may have the small area and the high integration density, so that the resolution of the display device 1 may increase.

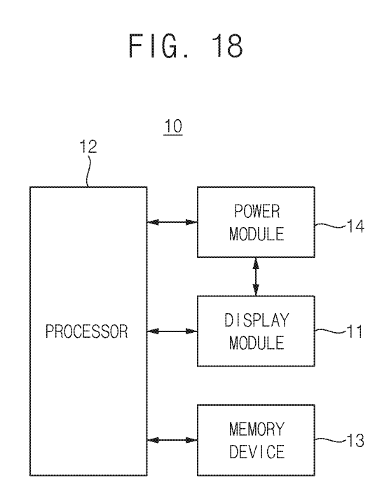

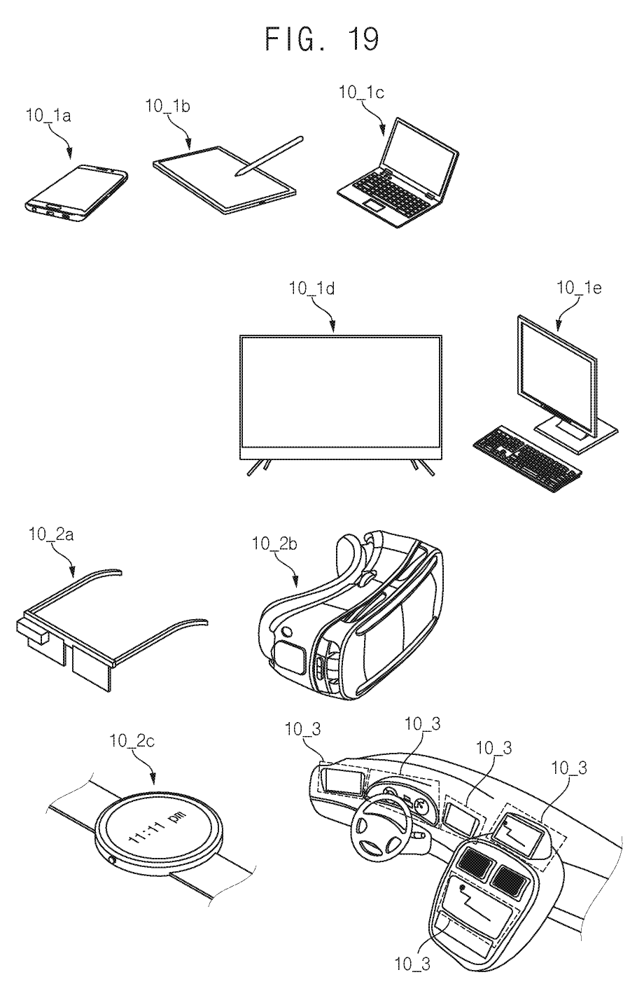

FIG. 18 is a block diagram illustrating an electronic device 10 according to embodiments of the invention. FIG. 19 is diagrams illustrating schematics of the electronic device 10 of FIG. 18.

Referring to FIG. 18, an embodiment of the electronic device 10 may include a display module 11, a processor 12, a memory device 13, and a power module 14.

The display device 1 according to embodiments of the invention may be applied to various electronic devices. In an embodiment, the electronic device 10 may include the display device 1 of FIG. 1. In an embodiment, the electronic device 10 may further include modules or devices having other additional functions in addition to the display device 1.

The processor 12 may include at least one selected from a central processing unit (CPU), an application processor (AP), a graphic processing unit (GPU), a communication processor (CP), an image signal processor (ISP), and controller.

In an embodiment, the processor 12 may generate the input control signal CONT of FIG. 1 and the input image data IMG of FIG. 1 and may provide the input control signal CONT of FIG. 1 and the input image data IMG of FIG. 1 to the driving controller 200 included in the display device 1 of FIG. 1.

In an embodiment, the processor 12 may be provided as two or more forms in terms of functionality or structure. In an embodiment, for example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 200 included in the display device 1 of FIG. 1. Accordingly, the main processor may provide the input control signal CONT of FIG. 1 and the input image data IMG of FIG. 1 to the auxiliary processor. The auxiliary processor may process the image signal based on the input control signal CONT and the input image data IMG.

The memory device 13 may include at least one selected from a non-volatile memory device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 14 may include a power supply module, such as a power adapter or a battery device, and a power conversion module that converts power supplied by the power supply module and generates power used for the operation of the electronic device 10.

At least one of the components of the electronic device 10 may be included in the display device 1. In addition, some of individual modules functionally included in one module may be included in the display device 1 and others may be provided separately from the display device 1. In an embodiment, for example, the display device 1 may include the display module 11, and the processor 12, the memory device 13, and the power module 14 may be provided in the form of other devices in the electronic device 10, other than the display device 1.

Referring to FIG. 19, the various electronic devices having the display device 1 may include an image display electronic device such as a smart phone 10_1a, a tablet personal computer (PC) 10_1b, a laptop computer 10_1c, a television (TV) 10_1d, a desk monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

In an embodiment, the electronic device 10 may include the display device 1 of FIG. 1 and the display device 1 may include the display panel 100. The display panel 100 may include the pixel circuit PX.

In an embodiment, the pixel circuit PX may include the driving current generating circuit 20, the first emission circuit 30, the second emission circuit 40, the first emission control circuit 50, and the second emission control circuit 60. In an embodiment, for example, the first emission circuit 30 may be disposed in the N-th pixel row and the second emission circuit 40 may be disposed in the (N+1)-th pixel row.

In such an embodiment, the first emission circuit 30 and the second emission circuit 40 may share the driving current generating circuit 20, so that the number of transistors and the number of capacitors included in the display panel 100 may decrease. The number of transistors and the number of capacitors included in the display panel 100 decrease, so that the integration density of the pixel circuit PX included in the display panel 100 may increase. That is, the PPI may increase. Accordingly, the pixel circuit PX may have the small area and the high integration density, so that the resolution of the display device 1 may be increased.

Embodiments of the invention may be applied to a display device and an electronic device including the display device, for example, a TV, a digital TV, a three-dimensional (3D) TV, a mobile phone, a smart phone, a tablet computer, a laptop computer, a PC, a household electronic device, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel circuit comprising:
a driving current generating circuit which receives a data voltage and generates a driving current based on the data voltage;
a first emission circuit including a first light emitting element which emits light based on the driving current;
a second emission circuit including a second light emitting element which emits light based on the driving current;
a first emission control circuit which controls an emission of the first light emitting element and an emission of the second light emitting element; and
a second emission control circuit which transmits the driving current to the first emission circuit or the second emission circuit.

2. The pixel circuit of claim 1, wherein the driving current generating circuit includes:
a first transistor including a control electrode connected to a first node, a first electrode connected to a second node, and a second electrode connected to a third node;
a second transistor including a control electrode which receives a writing gate signal, a first electrode which receives the data voltage, and a second electrode connected to the first node; and
a storage capacitor including a first electrode connected to the first node and a second electrode connected to the second node.

3. The pixel circuit of claim 2, wherein the first emission control circuit includes a third transistor including a control electrode which receives a first emission signal, a first electrode which receives a first power supply voltage, and a second electrode connected to the second node.

4. The pixel circuit of claim 3, wherein the second emission control circuit includes:
a fourth transistor including a control electrode which receives a first control gate signal, a first electrode connected to the third node, and a second electrode connected to an anode electrode of the first light emitting element; and
a fifth transistor including a control electrode which receives a second control gate signal, a first electrode connected to the third node, and a second electrode connected to an anode electrode of the second light emitting element.

5. The pixel circuit of claim 4, wherein the first emission circuit further includes:
a sixth transistor including a control electrode which receives a first initialization gate signal, a first electrode connected to the anode electrode of the first light emitting element, and a second electrode which receives an initialization voltage,
wherein the first light emitting element includes the anode electrode connected to the first electrode of the sixth transistor and a cathode electrode which receives a second power supply voltage.

6. The pixel circuit of claim 4, wherein the second emission circuit further includes:
a seventh transistor including a control electrode which receives a second initialization gate signal, a first electrode connected to the anode electrode of the second light emitting element, and a second electrode which receives an initialization voltage,
wherein the second light emitting element includes the anode electrode connected to the first electrode of the seventh transistor and a cathode electrode which receives a second power supply voltage.

7. The pixel circuit of claim 3, wherein the first emission control circuit further includes an eighth transistor including a control electrode which receives a second emission signal, a first electrode which receives the first power supply voltage, and a second electrode connected to the second node.

8. The pixel circuit of claim 2, wherein the driving current generating circuit further includes a ninth transistor including a control electrode which receives a third initialization gate signal, a first electrode connected to the first node, and a second electrode which receives a reference voltage.

9. A display device comprising:
a display panel including a pixel circuit; and
a display panel driver which drives the display panel,
wherein the pixel circuit includes:
a driving current generating circuit which receives a data voltage and generates a driving current based on the data voltage;
a first emission circuit including a first light emitting element which emits light based on the driving current;
a second emission circuit including a second light emitting element which emits light based on the driving current;
a first emission control circuit which controls an emission of the first light emitting element and an emission of the second light emitting element; and
a second emission control circuit which transmits the driving current to the first emission circuit or the second emission circuit.

10. The display device of claim 9, wherein the driving current generating circuit includes:
a first transistor including a control electrode connected to a first node, a first electrode connected to a second node, and a second electrode connected to a third node;
a second transistor including a control electrode which receives a writing gate signal, a first electrode which receives the data voltage, and a second electrode connected to the first node; and
a storage capacitor including a first electrode connected to the first node and a second electrode connected to the second node.

11. The display device of claim 10, wherein the first emission control circuit includes a third transistor including a control electrode which receives a first emission signal, a first electrode which receives a first power supply voltage, and a second electrode connected to the second node.

12. The display device of claim 11, wherein the second emission control circuit includes:
a fourth transistor including a control electrode which receives a first control gate signal, a first electrode connected to the third node, and a second electrode connected to an anode electrode of the first light emitting element; and
a fifth transistor including a control electrode which receives a second control gate signal, a first electrode connected to the third node, and a second electrode connected to an anode electrode of the second light emitting element.

13. The display device of claim 12, wherein the first emission circuit further includes:
a sixth transistor including a control electrode which receives a first initialization gate signal, a first electrode connected to the anode electrode of the first light emitting element, and a second electrode which receives an initialization voltage,
wherein the first light emitting element includes the anode electrode connected to the first electrode of the sixth transistor and a cathode electrode which receives a second power supply voltage.

14. The display device of claim 13, wherein the second emission circuit further includes:
a seventh transistor including a control electrode which receives a second initialization gate signal, a first electrode connected to the anode electrode of the second light emitting element, and a second electrode which receives the initialization voltage,
wherein the second light emitting element includes the anode electrode connected to the first electrode of the seventh transistor and a cathode electrode which receives the second power supply voltage.

15. An electronic device comprising:
a processor which generates an input control signal and input image data;
a display panel including a pixel circuit; and
a display panel driver which drives the display panel based on the input control signal and the input image data,
wherein the pixel circuit includes:
a driving current generating circuit which receives a data voltage and generates a driving current based on the data voltage;
a first emission circuit including a first light emitting element which emits light based on the driving current;
a second emission circuit including a second light emitting element which emits light based on the driving current;
a first emission control circuit which controls an emission of the first light emitting element and an emission of the second light emitting element; and
a second emission control circuit which transmits the driving current to the first emission circuit or the second emission circuit.

16. The electronic device of claim 15, wherein the driving current generating circuit includes:
a first transistor including a control electrode connected to a first node, a first electrode connected to a second node, and a second electrode connected to a third node;
a second transistor including a control electrode which receives a writing gate signal, a first electrode which receives the data voltage, and a second electrode connected to the first node; and
a storage capacitor including a first electrode connected to the first node and a second electrode connected to the second node.

17. The electronic device of claim 16, wherein the first emission control circuit includes a third transistor including a control electrode which receives a first emission signal, a first electrode which receives a first power supply voltage, and a second electrode connected to the second node.

18. The electronic device of claim 17, wherein the second emission control circuit includes:
a fourth transistor including a control electrode which receives a first control gate signal, a first electrode connected to the third node, and a second electrode connected to an anode electrode of the first light emitting element; and
a fifth transistor including a control electrode which receives a second control gate signal, a first electrode connected to the third node, and a second electrode connected to an anode electrode of the second light emitting element.

19. The electronic device of claim 18, wherein the first emission circuit further includes:
a sixth transistor including a control electrode which receives a first initialization gate signal, a first electrode connected to the anode electrode of the first light emitting element, and a second electrode which receives an initialization voltage,
wherein the first light emitting element includes the anode electrode connected to the first electrode of the sixth transistor and a cathode electrode which receives a second power supply voltage.

20. The electronic device of claim 18, wherein the second emission circuit further includes:
a seventh transistor including a control electrode which receives a second initialization gate signal, a first electrode connected to the anode electrode of the second light emitting element, and a second electrode which receives an initialization voltage,
wherein the second light emitting element includes the anode electrode connected to the first electrode of the seventh transistor and a cathode electrode which receives a second power supply voltage.
